(19) United States
(12) Patent Application Publication
(10) Pub. No.: US 2015/0078728 A1
(43) Pub. Date: Mar. 19, 2015

(54) AUDIO-VISUAL WORK STORY ANALYSIS SYSTEM BASED ON TENSE-RELAXED EMOTIONAL STATE MEASUREMENT AND ANALYSIS METHOD

(71) Applicant: INDUSTRY-ACADEMIC COOPERATION FOUNDATION, DANKOOK UNIVERSITY, Yongin-si Gyeonggi-do (KR)

(72) Inventors: Jeonggueon Woo, Yongin-si, Gyeonggi-do (KR); Won Sik Kim, Daejeon (KR); Yong Taek Han, Gunpo-si Gyeonggi-do (KR)

(21) Appl. No.: 14/389,397

(22) PCT Filed: Mar. 28, 2013
(86) PCT No.: PCT/KR2013/002575

§ 371 Date: Sep. 30, 2014

(30) Foreign Application Priority Data
Mar. 30, 2012 (KR) 10-2012-0033130

(51) Int. Cl. H04N 21/442; H04N 21/44; G11B 27/34

(52) U.S. Cl. CPC H04N 21/44218; G11B 27/34; H04N 21/44008
USPC 386/230

(57) ABSTRACT

A video-work story analysis system (100) based on emotional state measurement includes a content provision unit (110) which provides story content of a video-work, a display unit (120) which displays content provided by the content provision unit (110), an emotional state measurement unit (130) which measures a tense-relaxed emotional state of a viewer viewing the displayed story content, a story pattern analysis unit (140) which analyzes the tense-relaxed emotional state measured by the emotional state measurement unit (130) according to a scene in the story content provided by the content provision unit (110), and a story pattern display unit (150) which prints out an analysis result or display the analysis result as an image. A writer may obtain support in an additional scenario modification work, and an investor may obtain support in making a decision through the above description.

### TECHNICAL FIELD

The present invention relates to a system which measures an emotional state of a viewer and analyzes a story of a video-work and a method using the same. In particular, the present invention relates to an analysis system which determines a story pattern per each video-work scene after measuring a tense or relaxed state of the viewer and a method using the same.

### BACKGROUND ART

According to the technology advancement in recent years, various approaches such as 3D films, an IPTV, a mobile communication terminal, a clouding computer, and the like to cultural content have been introduced. Moreover, a movie, an animation, a drama, a fiction, and the like which provide cultural content are largely produced.

In the field of modern social culture, art, or entertainment, the most important factor accounted for is the content. Therefore, a discovery and research & development on the content are considered as important fields.

In particular, in a movie, an animation, etc., a development of a tool, which supports a plan and development of storytelling which is a core and basis of a popular narrative genre, is demanded. Furthermore, through a story or a scenario of a video-work, a method or a system development capable of forecasting a box-office success or failure on a video-work such as a movie, a drama, or the like is demanded.

### DISCLOSURE

### Technical Problem

According to the present invention, a video-work story analysis system and an analysis method based on emotional state measurement are provided to solve the following issues.

First, the present invention is directed to measuring an emotional state change of a viewer watching the story content of a video-work, and analyzing a video-work story.

Second, the present invention is directed to determining a tense or relaxed state of a viewer through a brainwave analysis, a vital sign analysis, an ocular state analysis, expressing a result in a numeric value, and analyzing a pattern in each scene of a video-work.

Third, the present invention is directed to evaluating a story or scenario of a corresponding video-work through an emotional state analysis of a viewer, and assisting in a scenario work, an editing work, or an estimation of investment.

The technical objectives of the present invention are not limited to the above disclosure, other objectives may become apparent to those of ordinary skill in the art based on the following descriptions.

### Technical Solution

According to an aspect of the present invention, a video-work story analysis system based on emotional state measurement includes a content provision unit which provides story content of a video-work, a display unit which displays content provided by the content provision unit, an emotional state measurement unit which measures a tense-relaxed emotional state of a viewer viewing the displayed story content, a story pattern analysis unit which analyzes the tense-relaxed emotional state measured from the emotional state measurement unit according to a scene in the story content provided by the content provision unit, and a story pattern display unit which prints out an analysis result or displays the analysis result as an image.

The emotional state measurement unit measures a tense or relaxed emotional state through one or more analyses among a brainwave analysis, a vital sign analysis, or an ocular state analysis.

The content provision unit further provides a story tag to distinguish a scene in the story content.

The story pattern analysis unit matches and analyzes the tense-relaxed state measured from the emotional state measurement unit from story content divided into a scene with reference to the story tag.

The story pattern display unit displays a story content section on one axis of two axes in a two-dimensional graph with the same interval, and draws a graph of a numerical value of a tense-relaxed emotional state on the other axis.

According to another aspect of the present invention, the video-work story method of analysis based on emotional state measurement includes storing the story content of the video-work into a storage device, replaying the story content stored in the storage device from a replaying device, measuring the tense-relaxed emotional state of the viewer viewing the story content replayed through an emotional state measurement device, performing a comparative analysis with respect to a measured tense-relaxed emotional state and a scene in story content, and displaying the analysis result through the output device.

### Advantageous Effects

According to the present invention, a video-work story analysis system and analysis method based on emotional state measurement analyzes a tense or relaxed state of a viewer viewing story content of a video-work, and evaluates whether or not a corresponding video-work is a story or scenario capable of receiving a positive response from viewers. A writer may obtain support in an additional scenario modification work, and an investor may obtain support in making a decision through the above description. Furthermore, the video-work story analysis system and analysis method based on emotional state measurement may extract a particular pattern with respect to a change in an emotional state of a viewer, compile statistics, and analyze a correlation between a story and an emotional state.

The effects of the present invention are not limited to the above disclosure, other objectives may become apparent to those of ordinary skill in the art based on the following descriptions.

### DESCRIPTION OF DRAWINGS

FIG. 1 is a block diagram schematically illustrating a video-work story analysis system based on emotional state measurement according to an embodiment of the present invention.

FIG. 2 is a block diagram illustrating an operation of measuring an emotional state of a viewer in a video-work story analysis system based on emotional state measurement according to the embodiment of the present invention.

FIG. 3 is an example illustrating an output screen of an emotional state display unit of a video-work story analysis system based on emotional state measurement according to the embodiment of the present invention.

FIG. 4 is a flow chart schematically illustrating a video-work story method of analysis based on emotional state measurement.

### MODES OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

As used herein, the singular forms “a,” “an” and “the” are intended to include the plural forms as well, unless the context clearly means otherwise. It will be furthermore understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

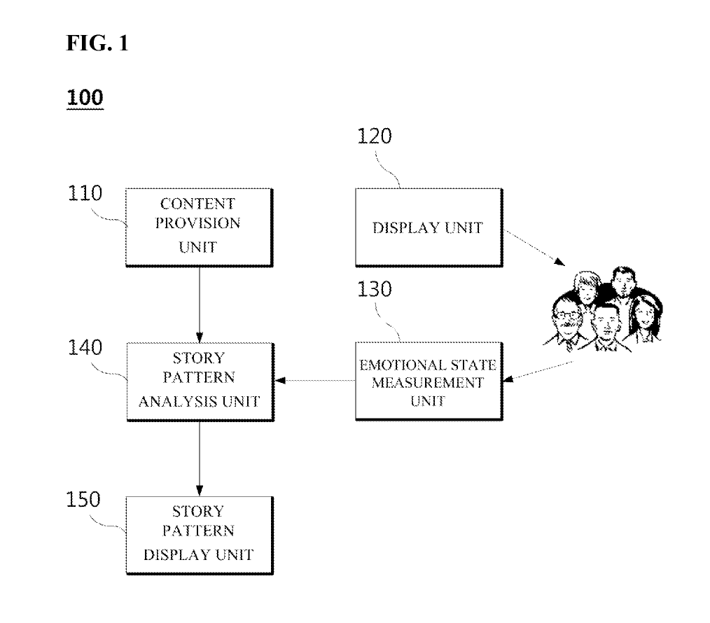

Prior to describing and illustrating figures in detail, a division of the configuration units in the present invention is intended for ease of description and divided only by the main function set for each configuration unit. That is, two or more of the configuration units to be described hereinafter may be combined into a single configuration unit or formed by two or more of divisions by function into more than a single configuration unit. Furthermore, each of the configuration units to be described hereinafter may additionally perform a part or all of the functions among functions set for other configuration units other than being responsible for the main function, and a part of the functions among the main functions set for each of the configuration units may be exclusively taken and certainly performed by other configuration units. Therefore, the existence of the configuration units each described through the present invention needs to be functionally interpreted, and due to such reasons, the configuration units referred in the video-work story analysis system 100 based on emotional state measurement of the present invention can be different from what is clearly stated in FIG. 1 and still fall within the limits of achieving the purpose of the present invention.

First, the terminology used herein is defined.

A video-work is defined as a creative work including consecutive images (sound inclusion is irrelevant) as defined in copyright law, and referred to as a thing which is able to be seen or watched as a video replayed by a machine or an electronic device.

Story content of the video-work is data outlining a story or a scenario of the video-work. Moreover, the story content is various data, of which the public can understand, including not only a movie recording itself but also a text such as a script, a video, a cartoon, an animation, etc. As related to the description above, the story content of the video-work can be watched, heard, or read. Presently, a traditional printout can be replaced by a display device, such as an e-book or the like, and a scene which is presently reading by, listening to, or seeing to a viewer can be distinguished by a function of an electronic device due to an advancement of an electronic device. Therefore, a person viewing the story content of the video-work is not limited to a viewer, a listener, or a reader, and expressed as a viewer. Finally a viewer includes a viewer, a listener, or a reader.

A video-work scene means an interval in a time sequence forming one story scene. The scene can be the smallest unit of progress in a drama, and usually changed by a change of a place or a time. Scene is a commonly used term in the corresponding field, and used with the same meaning in the present invention.

A tense-relaxed emotional state means an emotional state experienced by a viewer while viewing a video-work. Although an emotion can be interpreted as various emotions, it is interpreted as either a tense (tension) or relaxed (relaxation) state in the present invention. That is, in a scene which provides an impression, a thrill, or a pleasure while viewing a video-work, a state in which a viewer experiences tension is called a tense state and a state in which a scene with the tension has passed and returned to a normal state is called a relaxed state. In the embodiment of the present invention, a story of a video-work is analyzed by measuring a tense or relaxed state of a viewer. A tense or relaxed state of a viewer is generally measured by a variations in a heartbeat rate, respiration, a size of pupil, a body temperature, brainwaves, etc. Therefore, the story may be simply evaluated with reference to the strength and frequency of a tension, or may be determined as whether a viewer felt entertained or not by detecting a particular pattern.

Hereinafter, a video-work story analysis system 100 and an analysis method based on emotional state measurement will be described in detail with reference to the accompanying drawings.

First, the video-work story analysis system 100 will be described. FIG. 1 is a block diagram schematically illustrating a video-work story analysis system 100 based on emotional state measurement according to an embodiment of the present invention.

According to the present invention, the video-work story analysis system 100 based on emotional state measurement includes a content provision unit 110 which provides story content to a video-work, a display unit 120 which displays content provided by the content provision unit 110, an emotional state measurement unit 130 which measures a tense-relaxed emotional state of a viewer viewing displayed story content, a story pattern analysis unit 140 which analyzes the tense-relaxed emotional state measured from the emotional state measurement unit 130 according to a scene in the story content provided by the content provision unit 110, and a story pattern display unit 150 which prints out an analysis result or displays the analysis result as an image.

As described above, the story content is data outlining a story or a scenario of the video-work. Furthermore, the story content is various data, in which the public can understand, including a text such as a script, a video, a cartoon, an animation, etc. Story content in text form is named as a story text, and story content in visual image form is named as a story video. In the case of a printout such as a booklet, there is a difficulty of recognizing which part of a story is read by the viewer. Therefore, the story pattern analysis unit 140 needs a word by word manual input of the currently viewed scene. However, in the case of providing a text through an e-book or a tablet PC, the story pattern analysis unit 140 may recognize a story part currently provided by the electronic device.

The display unit 120 may replay the story content through a display device, an e-book, or a tablet PC, etc. A story replay unit replays the story content through various devices according to a type of the story content. The story video may be replayed by the story replay unit through a TV, a monitor, a projection device, etc. The story text may be replayed by the story replay unit through the monitor device, the e-book, the tablet PC, etc.

The emotional state measurement unit 130 measures the tense or relaxed emotional state through one or more analyses among state analyses of variations in brainwaves, changes in ocular states, or variations in vital signs such as a heartbeat rate, respiration, or a body temperature. Various studies on a method of measuring a tense or a relaxed state of a person have been conducted.

A method of using the brainwaves fundamentally measures the brainwaves generated during the video-work viewing after mounting a device configured to measure the brainwaves on the heads of a viewer. As a brief description, the method includes measuring brainwaves (EEG) from a user's scalp, extracting an event-related brain potential (ERP) from the measured brainwaves (EEG) through a filtering and averaging process, and determining whether the extracted ERP is in a tense or a relaxed state. Furthermore, the strength of the tense or the relaxed state may be measured. Although there are slight differences among people, fundamentally, a flow of brainwaves generated during a tense state is common among people.

As well known in a corresponding field, brainwaves during a stable state are compared to brainwaves during a particular event (video-work viewing), and a two-dimensional space-frequency ERD/ERS pattern having event-related (de)synchronization (ERD/ERS, hereinafter ‘ERD/ERS’) data of a particular event may be utilized.

A tense or relaxed state may be measured by analyzing vital signs measured from a person under tension besides brainwaves. When a person is under tension, a pulse becomes rapid, a body temperature rises, and respiration becomes rapid. Therefore, a tense or a relaxed state of a viewer viewing a video-work may be measured by measuring an electrocardiogram (ECG), a blood pressure, a body temperature, skin conductivity, or respiration. The vital signs described in the present invention are typically the ECG, the blood pressure, the body temperature, the skin conductivity, or the respiration, but vital signs are not limited to the descriptions thereof and include all signals capable of measuring the tense state.

The emotional state measurement unit may numerically express the tense-relaxed state of the viewer after measuring the vital signs and performing a certain filtering and conversion process.

Furthermore, the tense or relaxed state may be measured by analyzing an ocular state of a person. The tense or relaxed state of the viewer may be measured by measuring a size of pupil, a frequency of eye blinking, or a speed of eye blinking

Moreover, besides brainwaves analysis, vital signs analysis, or ocular state analysis, any method capable of measuring a tense state of a person may be used, and a method combining the methods may be used.

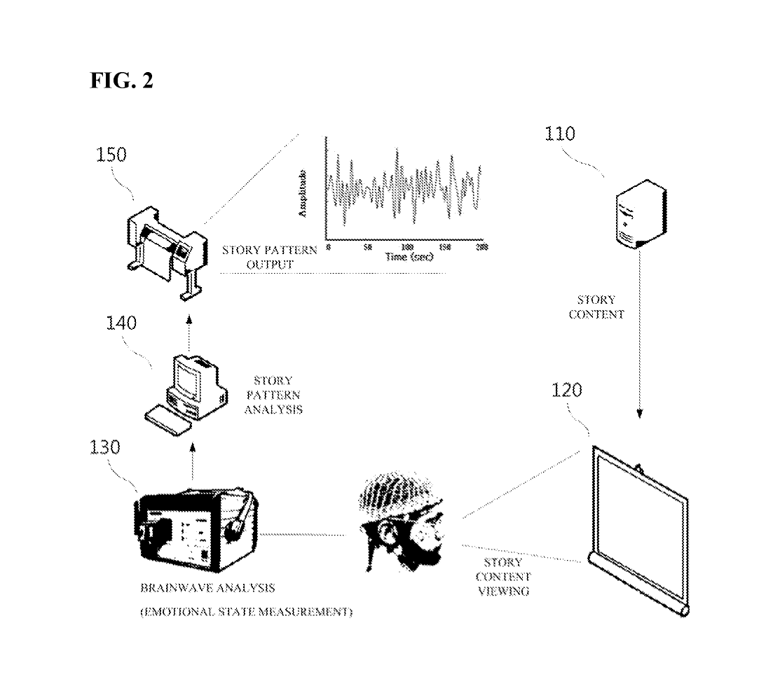

FIG. 2 is a block diagram illustrating an operation of measuring an emotional state of a viewer in a video-work story analysis system 100 based on emotional state measurement according to the embodiment of the present invention. A tense-relaxed state measurement is assumed to be performed with a brainwaves measurement in FIG. 2.

A content provision unit 110 formed with a story storage unit and a content replay unit may be included in a computer device, or may be a device connected through wired or wireless communication. The story storage unit may use a hard disk, a USB memory device, a DVD device, or a device such as a server connected to the Internet.

When the content provision unit 110 is in a remote place in a server form, a viewer views corresponding story content by streaming, or views after downloading. A tense-relaxed state of the viewer is measured from brainwaves and vital signs generated during viewing of story content by using the above-described device.

A measurement result with respect to the tense-relaxed emotional state of the viewer measured by an emotional state measurement unit 130 is entered into to a story pattern analysis unit 140. The story pattern analysis unit 140 performs a comparative analysis on the measurement result with respect to content related data and the tense-relaxed emotional state of the viewer provided from the content provision unit 110. The story pattern analysis unit 140 matches the tense-relaxed emotional state of the viewer measured per each scene in the story content, and analyzes a change shown in a corresponding interval.

Emotional state data of the viewer and content scene data may be shown in a two-dimensional planar graph, and a story pattern display unit 150 may include a monitor device, a printer device, etc. Furthermore, a result of the data may be output through a mobile communication terminal such as user's smart phone or a tablet PC. A plotter which outputs a graph is illustrated as an example of the story pattern display unit 150 in FIG. 2. An example illustrating a graph displaying the tense-relaxed emotional state on a right upper portion of the story pattern display unit 150 is illustrated in FIG. 2.

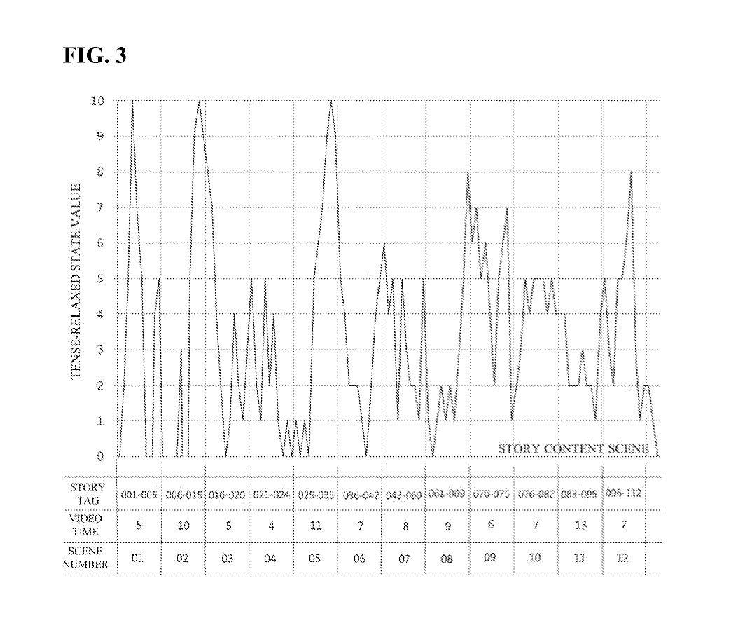

FIG. 3 is an example illustrating an output screen of the story pattern display unit 150 of a video-work story analysis system 100 based on emotional state measurement according to the embodiment of the present invention.

An x-axis is a scene in story content according a time flow, and a y-axis is a value with respect to a tense-relaxed state of a viewer. Although an emotional state may be expressed in various ways, the emotional state is illustrated in a range of 0 (zero) to 10 in FIG. 3. When the value is near 10, a tense state becomes high. When the value is near 0, tension is reduced and a state becomes a relaxed state.

A section measuring the emotional state of the viewer may be variously applied. The section is divided into uniform time intervals based on a story content replaying time, and the emotional state of a corresponding section may be displayed. Furthermore, the emotional state referencing a scene as a unit developing a content of the story content may be displayed. In a broader sense, compared to the scene, the section may be configured to group the scene based on a single topic. The section is divided based on the scene in the story content in FIG. 3. That is, the level of a tension or a relaxation from the viewer in the corresponding scene is displayed regardless of a video replaying time.

In a table shown in a lower portion of FIG. 3, a scene number is used to distinguish the scene in the story content sequentially, and a video time is a replaying time of the corresponding scene. Meanwhile, a story tag is a value to distinguish the corresponding scene in the video-work story analysis system 100 of the present invention.

The story tag with respect to each scene may be stored in the story content. That is, the content provision unit 110 may further provide the story tag to distinguish the story content according to the time.

In a system, the scene may be distinguished through the story tag, and the emotional state per each scene may be measured and displayed. Furthermore, when the scene is not used as a reference, the story tag capable of distinguishing the corresponding section is used. Referring to FIG. 3 as an example, a story tag corresponding to a scene number 05 is 0025-0035. Various values besides numbers may be used in an actual system.

A scene 05 is one of sections showing the viewer transitions from a relaxation state to the maximum tense state. That is, a story capable of giving tension to the viewer is developed from the scene 05. When the relaxation state lasts continuously, the story may be evaluated as slightly boring. That is, the story pattern analysis unit 140 may analyze the corresponding story content through an analysis of the emotional state change from the viewer in response to story flow in the present invention.

In FIG. 3, the x-axis displays the emotional state into the same interval per each scene regardless of the time duration. The story pattern analysis unit 140 may display the story content section on one axis (x or y) of two axes in a two-dimensional graph with the same interval, and draw a graph of a numerical value with respect to the tense-relaxed emotional state on the other axis. Furthermore, the emotional state may also be displayed by dividing the section according to the time flow.

Meanwhile, after making multiple measurements on the emotional state of the story content, a uniform pattern may be discovered. For example, a typical pattern may be found from a genre (drama, action, comedy, etc.) of the video-work, or a common pattern may be found in a video-work of the past box-office hit. When the above-described story pattern is established, it may be compared to the presently analyzed pattern of the video-work. That is, the story pattern analysis unit may determine whether or not the present video-work has a typical pattern from the genre, or whether or not a box-office has a chance to be a hit compared to the video-work of the conventional box-office hit. The story pattern analysis unit 140 illustrated in FIG. 1 corresponds to a configuration of a comparative analysis of an emotional pattern.

Meanwhile, the story pattern analysis unit 140 may utilize previously analyzed or accumulated data, store the typical pattern from the genre or a pattern from the box-office hit, and perform an analysis, or link (not shown) to a separate pattern database and perform a pattern analysis.

In the embodiment of the present invention and through the pattern analysis performed in the video-work story analysis system 100, a writer may modify or supplement a corresponding story or a scenario to fit into a typical pattern or the box-office hit pattern at a scenario writing stage, and an investor may decide whether or not to invest according to the corresponding story content at a business investment stage.

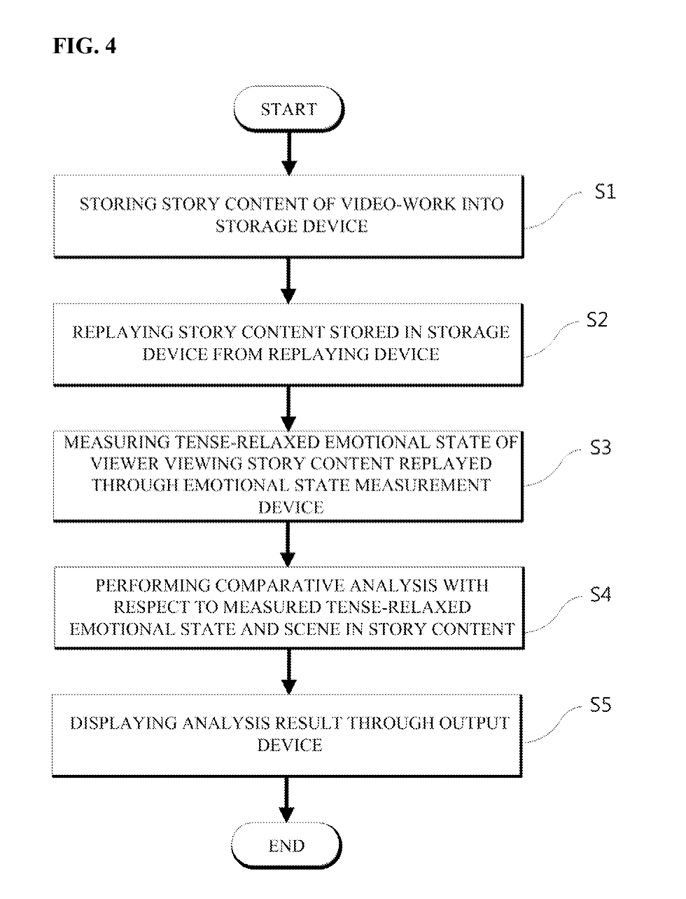

FIG. 4 is a flow chart schematically illustrating a video-work story method of analysis based on emotional state measurement. Duplicated descriptions with the above-described video-work story analysis system 100 among descriptions on the analysis method of the video-work story will be briefly described.

According to the embodiment of the present invention, the video-work story method of analysis based on emotional state measurement includes storing the story content of the video-work into a storage device (S1), replaying the story content stored in the storage device from a replaying device (S2), measuring the tense-relaxed emotional state of the viewer viewing the replayed story content through an emotional state measurement device (S3), performing a comparative analysis with respect to a measured tense-relaxed emotional state and a scene in story content (S4), and displaying the analysis result through the output device (S5).

As described above, the story content includes a story text or a story video.

In the embodiment of the present invention, each operation proceeds through a configuration in response to the above-described system or a separate device performing the same function.

The storage device used in a storing operation of the story content includes all types of storage media or servers capable of storing data. The storage device used in the content provision unit 110 of the video-work story analysis system 100 is the same as a storage medium.

The replaying device used in a replaying operation of the story content includes a stationary display device, an e-book, a tablet PC, etc. The emotional state measurement device in a measuring operation of the tense-relaxed emotional state includes a device performing one or more analyses among brainwaves analysis, vital signs analysis, or ocular movement analysis.

The storage device storing the story content may further store the story tag to distinguish the story according to the flow time of the story content.

The measuring operation of the tense-relaxed emotional state may measure the tense-relaxed emotional state of the viewer from story content divided into the scene with reference to the story tag, and numerically converting and displaying operations of the tense-relaxed emotional state may numerically convert and display the tense-relaxed emotional state per story content section.

Meanwhile, the story content section may be displayed with the same interval on one axis of the two axes in a two-dimensional graph, and a graph of a numerical value of the tense-relaxed emotional state may be drawn on the other axis in a displaying operation of the tense-relaxed emotional state.

While the present invention has been described above in detail with reference to representative embodiments, it may be understood by those skilled in the art that the embodiment may be variously modified without departing from the scope of the present invention. Therefore, the scope of the present invention is defined not by the described embodiment but by the appended claims, and encompasses equivalents that fall within the scope of the appended claims.

1. A video-work story analysis system based on a tense-relaxed emotional state measurement, comprising:
a content provision unit configured to provide story content of a video-work;
a display unit configured to display the story content provided to the content provision unit;
an emotional state measurement unit configured to measure a tense-relaxed emotional state of a viewer viewing the displayed story content;
a story pattern analysis unit configured to analyze the story content provided by the content provision unit and the tense-relaxed emotional state measured from the emotional state measurement unit ; and
a story pattern display unit configured to output an analyzed result from the story pattern analysis unit.

2. The video-work story analysis system according to claim 1, wherein the emotional state measurement unit measures a tense emotional state or a relaxed emotional state through one or more analyses among a brainwave analysis, a vital sign analysis, or an ocular state analysis.

3. The video-work story analysis system according to claim 1, wherein the content provision unit further provides a story tag to distinguish a scene in the story content.

4. The video-work story analysis system according to claim 3, wherein the story pattern analysis unit matches and analyzes the tense-relaxed state measured from the emotional state measurement unit from story content divided into scenes with reference to the story tag.

5. The video-work story analysis system according to claim 4, wherein the story pattern display unit displays a story content section on one axis of two axes in a two-dimensional graph with the same interval, and draws a graph of a numerical value of a tense-relaxed emotional state on the other axis.

6. A video-work story analysis method based on a tense-relaxed emotional state measurement, wherein the method comprises:
storing story content of a video-work into a storage device;
replaying the story content stored in the storage device from a replaying device;
measuring a tense-relaxed emotional state of a viewer viewing the story content replayed through an emotional state measurement device;
performing a comparative analysis with respect to the measured tense-relaxed emotional state and a scene in the story content; and
displaying the comparative analysis result through the output device.

7. The video-work story analysis method according to claim 6, wherein the emotional state measurement device measures a tense-relaxed emotional state through one or more analyses among a brainwaves analysis, a vital signs analysis, or an ocular movement analysis.

8. The video-work story analysis method according to claim 6, wherein a storage device configured to store the story content further stores a story tag to distinguish a scene in the story content.

9. The video-work story analysis method according to claim 8, wherein the displaying of the comparative analysis comprises:
matching a tense-relaxed emotional state of the viewer from story content divided into a scene with reference to the story tag; and
analyzing a tense-relaxed emotional state of the viewer from the story content divided into a scene with reference to the story tag.

10. The video-work story analysis method according to claim 9, wherein the displaying of the comparative analysis result comprises:
displaying a story content section on one axis of two axes in a two-dimensional graph with the same interval; and
drawing a graph of a numerical value of a tense-relaxed emotional state on the other axis.
